(19) United States
(12) Patent Application Publication
(10) Pub. No.: US 2007/0202023 A1
(43) Pub. Date: Aug. 30, 2007

(54) Reactor

(75) Inventors: Yuki Bessho, Aichi-pref (JP); Fumitake Takahashi, Aichi-pref (JP)

Correspondence Address: BURR & BROWN, PO BOX 7068, SYRACUSE, NY, 13261-7068, US

(73) Assignee: NGK INSULATORS, LTD., Nagoya-Shi, Aichi-Prefecture (JP)

(21) Appl. No.: 11/572,438

(22) PCT Filed: Jul. 26, 2005
(86) PCT No.: PCT/JP05/13996

§ 371 Date: Jan. 22, 2007

(30) Foreign Application Priority Data
Jul. 26, 2004 (JP) 2004-217450

(51) Int. Cl. B01J 8/02

(52) U.S. Cl. 422/222; 422/240

(57) ABSTRACT

A reactor RT1 comprises a flow passage forming member (10) having been formed by laminating a plurality of ceramic plates (11 to 13) and firing the resultant laminate and, provided inside the flow passage (R1) of the member, a porous body (20) having a three dimensional net-like structure and carrying a catalytic material. In the reactor, when a fluid before reaction flows through the flow passage (R1), the fluid inevitably passes through the inside of the porous body (20). Accordingly, the flow is contacted frequently with the catalytic material, and thus a reaction by the catalytic material with good efficiency is occurred, which allows the use of the reactor (RT1) having a smaller size.

### TECHNICAL FIELD

The present invention relates to a reactor generating a reaction including a steam-reforming reaction of hydrocarbon such as methane, methanol and the like, and a dehydrogenation reaction of cyclohexane, and so on.

### BACKGROUND ART

Conventionally, a catalytic apparatus having catalytic materials (catalysts) composed of precious metal and the like and walls composed of ceramic such as alumina is known. Surfaces of the walls are coated with the catalytic materials and form flow passages. The catalytic apparatus of this kind can be called as a reactor, since the apparatus generates and facilitates reactions between components of fluid.

However, the fluid flows in the center of the flow passages at high speed and does not flow inside of portions coated with the catalysts (i.e., catalytic layer) in the conventional reactor described above. Thus, in the conventional reactor, the reactions may be hard to be proceeded. Accordingly, in order to generate desirable reactions using the conventional reactors, it is necessary to increase a surface area of the catalytic layer by making the flow passages have a shape of a honeycomb or by lengthening the flow passages. As a result, a size of the conventional reactor becomes large, and therefore, is hard to be utilized as a reactor for generating hydrogen which, for instance, is a part of a fuel cell for an electronic device, the fuel cell being required to be small and to operate with high efficiency.

### DISCLOSURE OF INVENTION

A reactor according to the present invention is provided in order to solve the problems described above and comprises:

a flow passage forming member which has a space in its inside, the space being a flow passage formed by laminating and firing a plurality of ceramic plates, and

a porous body having a three dimensional net-like structure (or net-like-bones structure) disposed in said space for supporting a catalytic material.

According to the reactor described above, the porous body having the three dimensional net-like structure which supports the catalytic materials is disposed in the flow passage of the flow passage forming member. The flow passage is formed by laminating and firing a plurality of ceramic plates. Therefore, the fluid which has not reacted yet inevitably passes the inside of the porous body when the fluid flows in the flow passage. As a result, reactions by the catalyst (the catalytic material) occur efficiently, since the fluid contacts the catalytic material frequently. In addition, resistance to the fluid becomes small and pressure loss becomes small, since the porous body having the three dimensional net-like structure has a large porosity. In this manner, the reaction efficiency is improved according to the present invention, and therefore, the reactor having a smaller size can be provided.

Moreover, according to the present invention, a reactor is provided, the reactor comprising:

a body having in its inside a space formed by laminating and firing a plurality of ceramic plates, the body having a through-hole in a wall forming the space, and

a porous body having a three dimensional net-like structure disposed in said through-hole for supporting a catalytic material.

According to this reactor, fluid flowing into the space of the body via the through-hole from outside of the space, or fluid flowing outside of the space via the through-hole from the space, inevitably passes the porous body which has the three dimensional net-like structure and which supports the catalytic material. As a result, reactions by the catalyst occur efficiently, since the fluid contacts the catalytic material frequently. In this manner, the reaction efficiency is improved according to the present invention, and therefore, the reactor having a smaller size can be provided.

Embodiments according to the present invention will be described with reference to the drawings below. The present invention should not be interpreted as limiting to the embodiments described below, and various changes, modifications, and revisions can be added based on the knowledge of persons skilled in the art within the scope of the present invention.

### BRIEF DESCRIPTION OF THE DRAWINGS

FIG. 1 is a perspective view of the reactor according to a first embodiment of the present invention cut by a certain plane.

FIG. 2 is a sectional view of the reactor shown in FIG. 1 cut by a plane extending along line 1-1 of FIG. 1.

FIG. 3 is a sectional view of the reactor shown in FIG. 1 cut by a plane extending along line 2-2 of FIG. 1.

FIG. 4 is a view showing each state when manufacturing the porous body shown in FIG. 1.

FIG. 5 is a sectional view of a reactor according to a second embodiment of the present invention.

FIG. 6 is a schematic perspective view of each of plates configuring the reactor shown in FIG. 5 for explaining manufacturing methods of the reactor.

### BEST MODE FOR CARRYING OUT THE INVENTION

### First Embodiment

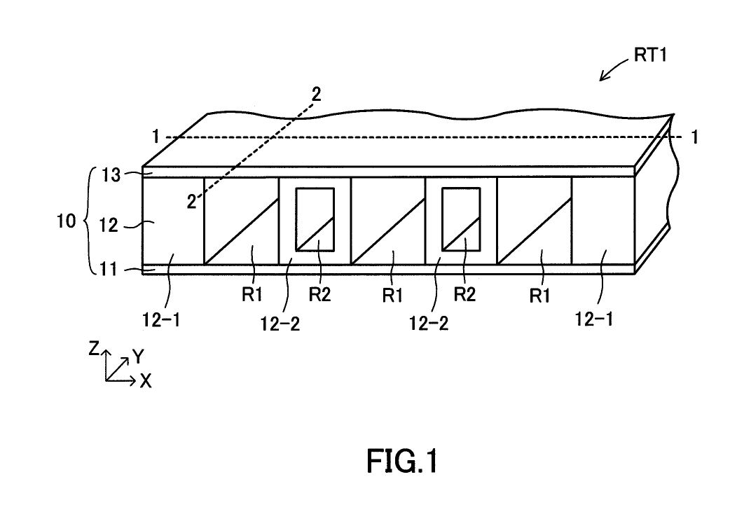

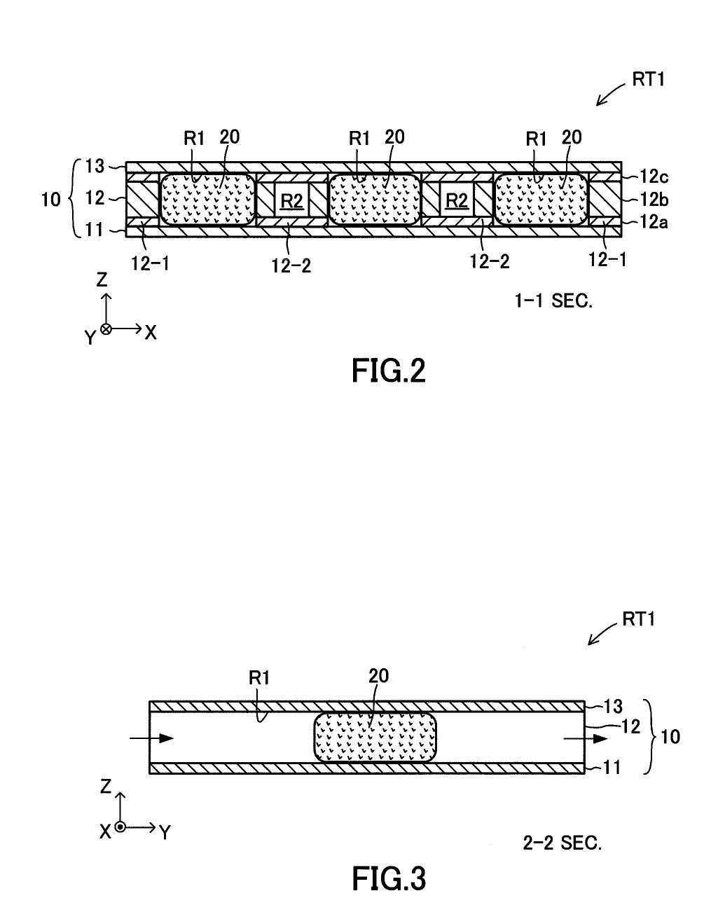

FIG. 1 is a perspective view of the reactor RT1 according to a first embodiment of the present invention cut by a certain plane. FIG. 2 is a sectional view of the reactor RT1 shown in FIG. 1 cut by a plane extending along line 1-1 of FIG. 1. FIG. 3 is a sectional view of the reactor shown in FIG. 1 cut by a plane extending along line 2-2 of FIG. 1. This reactor RT1 comprises a flow passage forming body 10 and a porous body 20.

The flow passage forming body 10 consists of a lower wall portion 11, a middle wall portion 12 and an upper wall portion 13. The flow passage forming body 10 is a rectangular parallelepiped having sides extending along directions of X axis, Y axis and Z axis which are mutually-perpendicular. The flow passage forming body 10 has a flow passage (space) R1 and a flow passage R2 (space) in its inside.

The lower wall portion 11 is a flat plate having sides extending along the directions of X axis, Y axis and Z axis.

The middle wall portion 12 comprises a first support portion 12-1 and a second support portion 12-2. Each of the first support portion 12-1 and the second support portion 12-2 has a shape of a rectangular parallelepiped having sides extending along the directions of X axis, Y axis and Z axis. The length in the direction of Z axis of the first support portion 12-1 is the same as the length in the direction of Z axis of the second support portion 12-2. Each of longitudinal directions of the first support portion 12-1 and the second support portion 12-2 is along the direction of Y axis.

As shown in FIG. 2, the middle wall portion 12 actually consists of three plates 12a, 12b and 12c. These plates 12a, 12b and 12c are integrated by firing. A shape of the plates 12a is the same as that of the plates 12c. Portions of the plates 12a and 12c corresponding to the flow passage R1 are punched out. Portions of the plates 12b corresponding to the flow passages R1 and R2 are punched out. In other words, the middle wall portion 12 consists of the first support portion 12-1 which does not have a space (or a cavity) corresponding to the flow passage R2 in its inside, and the second support portion 12-2 which has a space (or a cavity) corresponding to the flow passage R2 in its inside.

An upper wall portion 13 is a plate having sides extending along the directions of X axis, Y axis and Z axis.

The lower wall portion 11, the middle wall portion 12 and the upper wall portion 13 are fixedly integrated by laminating in sequence ceramic flat plates (ceramic green sheets) having shapes corresponding to each portions, and by subsequently firing the ceramic flat plates. In this manner, the flow passage forming body 10 having the flow passages R1 and R2 are formed.

The flow passage R1 is defined by an upper surface of the lower wall portion 11, side wall surfaces of the spaces formed in the middle wall portion 12 and a lower surface of the upper wall portion 13. A longitudinal axis direction (streamline direction) of the flow passage R1 is along Y axis. The flow passage R2 is defined by an upper surface of the plate 12a of the middle wall portion 12, side wall surfaces of the spaces formed in the plate 12b of the middle wall portion 12 and a lower surface of the plate 12c of the middle wall portion 12. A longitudinal axis direction (streamline direction) of the flow passage R2 is also along Y axis.

The flow passage forming body 10 (i.e., the lower wall portion 11, the middle wall portion 12 and the upper wall portion 13) consists of typical ceramic such as zirconia or alumina, or ceramic having high resistance to thermal shock such as cordierite, silicon nitride or silicon carbide.

The porous body 20 has a three dimensional net-like structure and supports platinum as a catalytic material. The porous body 20 is disposed (or arranged) in a predetermined location inside the flow passage R1 and fixed to the flow passage R1. The porous body 20 is arranged such that it exists to cover almost entire section of the flow passage R1. That is, outer portion of the porous body 20 contacts with most portions of the walls which define (or compose) the flow passage R1 and is apart from the walls by a short distance at corners or the like of the flow passage R1.

Fluid such as cyclohexane which is a raw material is supplied into the flow passage R1. In addition, if the reaction by the catalyst is an endothermic reaction, high temperature fluid is supplied into the flow passage R2. As a result, the flow passage R2 functions as a heating portion and the heat generated from the heating portion expedites the reaction by the catalyst. Alternatively, a heat generator such as nichrome wire may be buried in the flow passage R2, instead of flowing the high temperature liquid in the flow passage R2.

[Method for Manufacturing the Porous Body 20]

Next, a method for manufacturing the porous body 20 will be described briefly. In this manufacturing method, a raw material is prepared, the law material being prepared by dissolving TMOS (tetramethoxysilane) or the like which is a silica source in water serving as a solvent. Secondly, a solution including a metal (platinum, in this example) which is the catalytic material is added to the raw material. Subsequently, a gelatinized material (or a gel) is produced from the raw material by a gelation reaction. Then, the gelatinized material is filled into the flow passage R1 to be arranged in the predetermined location in the flow passage R1 and freeze-dried, and thereafter, it is fired under ambient atmosphere. By the method described above, the porous body 20 having the three dimensional net-like structure and supporting the catalyst material is obtained. The porous body 20 is so called “Cryo-Gel (a porous structure)”.

It is preferable that freezing dry process in the manufacturing method described above is performed under the condition that the temperature at the trap portion is not greater than −80° C. and the degree of vacuum is not greater than 10 Pa. This is because the freezing dry of the gel may complete imperfectly, and thus, the structure may break down by a subsequent shrinkage while being dried, if the temperature at the trap portion is higher than −80° C., or, the degree of vacuum is greater than 10 Pa.

More specifically, the freezing dry described above is performed as below. Firstly, the gelatinized material (the wet gel) is placed in a chamber to be cooled at temperatures of −80° C. or low till the freezing of the gelatinized material is confirmed. It is desirable that the freezing be performed as instantaneously as possible, using a cooling medium such as dry ice—ethanol or liquid nitrogen. This is because the break down of the structure of the gelatinized material can be avoided when the gelatinized material is frozen by cooling instantaneously.

After confirmation of the freezing, the pressure in the chamber is kept at a vacuum for a period approximately from one to three days, while keeping the cooling temperature at the trap portion not greater than −180° C. The period depends on a size, density and a shape of the gelatinized material.

[Main Composition of the Raw Material of the Porous Body Described Above]

It is preferable that a main composition of the raw material consist of at least any one or a combination of silica, alumina, zirconia and titania. Particularly, it is more preferable that the main composition of the raw material consist of alumina and silica.

[Catalytic Material]

The catalytic material contained in the solution which is added to the raw material described above, contains one metal species of metal ion, metal minute particle and meal-oxide particle. The metal species includes gold, silver, platinum, palladium, nickel, ruthenium, rhodium, iron, cobalt, copper, zinc and so on. That is, a precious metal or a transition metal and the like are included in the metal species. It is preferable that a particle diameter of the metal species be, but not limited to, not greater than 5 nm to improve the catalytic ability.

The metal compound added to the raw material is reduced to metal particles by the firing process under air after the freezing dry process. The metal particles exert catalytic function. An additional firing under hydrogen atmosphere after the firing process can control degree of exposure of the metal particles dispersed in the porous body 20.

This manufacturing method excels in safety and can reduce energy consumption, since it uses the freezing dry process carried out under low temperature and low pressure, instead of supercritical dry process carried out under high temperature and high pressure. Additionally, the gelatinized material can be dried in the freezing dry process as it is, whereas the supercritical drying process requires water in liquid phase of the gelatinized material (the wet gel) to be replaced by alcohol. Therefore, the freezing dry process may simplify the whole dry processes, and thereby, can reduce the manufacturing costs greatly.

Furthermore, the porous body 20 obtained by the manufacturing method described above possesses distinguished water resistance. Therefore, the structure of the porous body 20 is not destroyed when it contacts water. In addition, the structure of the porous body 20 is not destroyed when it is dried again after it contacts with water. As a result, according to the manufacturing method described above, it is possible to make the porous body support the metal by a conventional impregnation method to impregnate the porous body into water solution containing metal ion, without adding the solution containing the catalytic material to the raw material as described above.

### SPECIFIC EXAMPLE OF PRODUCING PROCESSES FOR THE POROUS BODY 20 . . . EXAMPLE 1 OF PRODUCING PROCESSES

The specific example of producing processes for the porous body 20 will next be described. Regarding the porous body 20 produced by this example, the main component of a base material consists of silica (Sio₂). Furthermore, in the porous body 20, platinum (Pt) are dispersed as the catalytic material.

(1) Gelation Process

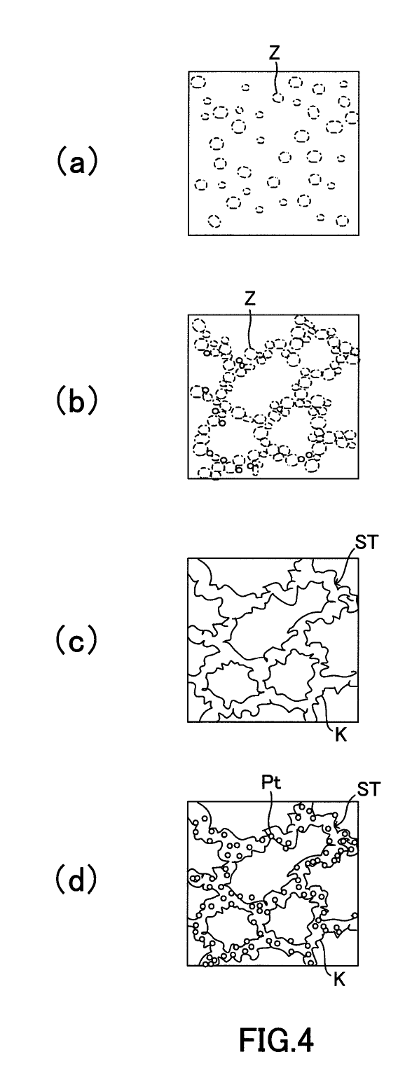

Firstly, platinic acid (HCPA: hexachloroplatinic acid hexahydrate [H₂ (PtCl₆).6H₂O) and TOMS (tetramethoxysilane) as a silica source are dissolved in water serving as a solvent. Accordingly, as a result of hydrolysis, silica (SiO₂) is generated as a nanoparticle, fine networks are formed by particle coupling and the silica deposition, and thus, the raw material is gelatinized. The gelation reaction here is a reaction between TMOS and H₂O which couples two TMOS molecules each other. By the repeat of the couplings, silica nanoparticles Z which are sol are generated as shown in FIG. 4(a).

The number of the silica nanoparticles Z increases, while each size of them becomes larger. As a result, the silica nanoparticles Z couple to form networks as shown in FIG. 4(b), and then the gel-bones structure ST is formed as shown in FIG. 4(c).

(2) Drying Process

The gel (the wet gel) having the gel-bones structure ST formed as described above is frozen at temperatures not greater than −80° C. After it is confirmed that the gel is frozen, the gel is retained for one to three days under substantial vacuum, while the temperature in the trap portion is kept not greater than −80° C. If the wet gel described above is dried according to the normal drying method, the gel-bones structure ST having the networks is destroyed by the surface tension generated when the gel is dried. On the other hand, in this example, the gel is dried using freeze-drying method. Thus, the adverse impact generated by the surface tension can be disappeared. As a result, the dried gel (the Cryo-Gel) keeping the gel-bones structure ST forming the networks is obtained.

(3) Firing Process

Next, the dried gel is heated and fired. This causes the platinic acid added as the platinum source to self-degrade (or to be reduced), and thus, the platinum is obtained. In this example, the dried gel is held at 500° C. for about one hour under air. It should be noted that the self-degradation temperature of the hexachloroplatinic acid described above ranges from 400° C. to 430° C.

At this time, the surface of the platinum partially exists in a form of platinum oxide. Therefore, the dried gel is fired under the hydro atmosphere (hydrogen reduction treatment is performed) to reduce the platinum oxide to platinum. In this manner, Pt/SiO₂ Cryo-Gel (the porous body 20 supporting platinum serving as the catalytic material) is produced.

In this porous body 20, the platinum Pt particles which are metal are almost buried in the base material (silica) K forming the three dimensional net-like structure ST, as shown in FIG. 4(d). The degree of the exposure of the platinum Pt can be appropriately adjusted by adjusting the conditions for the hydrogen reduction treatment described above.

### SPECIFIC EXAMPLE OF PRODUCING PROCESSES FOR THE POROUS BODY 20 . . . EXAMPLE 2 OF PRODUCING PROCESSES

Next, a manufacturing method for the porous body whose base material consists of alumina (Al₂O₂), the porous body having the three dimensional net-like structure in which platinum (Pt) are dispersed as the catalytic material, is briefly described.

(1) Solation Process

ASB [Al (sec-BuO)₃] or AlP [Al (iso-PrO)₃], serving as a alumina source, is mixed into water as a solvent. Then, after alkoxide hydrolysis, HNO₃ solution is added to it and it is retained for a predetermined period of time. As a result, a boehmite sol (AlOOH) is produced.

(2) Gelation Process

After a platinum source protected by a chelating agent is added to the boehmite sol, urea is added to the sol, then, the sol is retained in this state for the predetermined period of time. Subsequently, the sol is kept at a predetermined temperature for another predetermined period of time. As a result, an HCPA/boehmite gel (AlOOH) is produced.

(3) Drying Process

The HCPA/boehmite gel (AlOOH) is frozen at temperatures not greater than −80° C. After it is confirmed that the gel is frozen, the gel is retained for a predetermined period of time under substantial vacuum, while the temperature in the trap portion is kept not greater than −80° C. As a result, the dried gel (the Cryo-Gel) keeping the gel-bones structure ST forming the networks is obtained.

(4) Firing Process

Next, the dried gel is heated to be fired. This causes the platinic acid added as the platinum source to self-degrade (or to be reduced), and thus, the platinum is obtained. Also in this example, the dried gel is held at 500° C. for about one hour under air. As a result, the porous body 20 having the three dimensional net-like structure which supports the platinum is formed.

As described above, in the reactor RT1 according to the first embodiment, the porous body 20 having the three dimensional net-like structure which supports platinum is arranged in the flow passage (R1) of the flow passage forming member (10) formed by laminating and firing a plurality of the ceramic plates (11 to 13). This makes liquid which has not reacted inevitably pass inside the porous body 20 when the liquid flows in the flow passage (R1). Therefore, since the liquid frequently contacts the catalytic material, the reaction by the catalyst can be effectively generated. As a result, the smaller size reactor RT1 can be provided.

### Second Embodiment

Next, a reactor RT2 according to a second embodiment of the present invention is described. This reactor RT2 utilizes a steam-reforming reaction (CH₃OH+H₂O=CO₂+3H₂) using methanol in order to generate hydrogen used for a small size fuel cell.

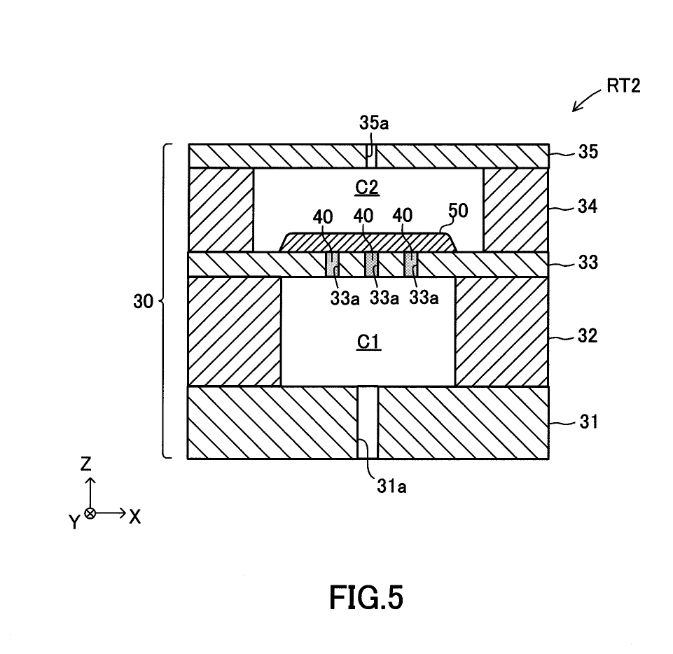

This reactor RT2 consists of a body 30, porous bodies 40 and a hydrogen separation membrane 50, as shown in FIG. 5 which is a cross-sectional view of the reactor RT2.

The body 30 is formed by sequentially laminating a plurality of ceramic plates (a first plate 31 to a fifth plate 35), each of which has a predetermined shape, and by firing these plates. The outer shape of the body 30 is a rectangular parallelepiped. A first space C1 and a second space C2 are formed inside the body 30. The first space C1 is defined by an upper surface of the first plate 31, inner wall surfaces of the second plate 32 and a lower surface of the third plate 33. The second space C2 is defined by an upper surface of the third plate 33, inner wall surfaces of the forth plate 34 and a lower surface of the fifth plate 35.

A through-hole 31a is formed in the first plate 31. A plurality of through-holes 33a are formed in the third plate 33. A through-hole 35a is formed in the fifth plate 35.

The porous body 40 has a three dimensional net-like structure which supports a catalytic material, as is the case with the porous body 20 which the reactor RT1 according to the first embodiment comprises. Each of the porous bodies 40 is disposed in each of the through-holes 33a. The catalytic material supported by the porous body 40 is Cu or Cu/ZnO.

The hydrogen separation membrane 50 is fixed on the upper surface of the third plate 33 to cover the plurality of through-holes 33a. The hydrogen separation membrane 50 is a thin membrane consisting of alloy of palladium and silver.

The hydrogen separation membrane 50 is formed as below.

(1) Sol in which nanometer-sized superfine particles of palladium—silver alloy (hereinafter referred to simply as “sol of palladium—silver alloy”) have been dispersed in a dispersant is prepared.

The sol of palladium—silver alloy is produced by a publicly known method such as a mechanochemical method and a method using Sol-Gel reaction of an organometallic compound. These methods are known as producing processes for manufacturing sol of palladium—silver alloy used for an electrode of a ceramic condenser and the like.

(2) The surface of the third plate 33 is coated with the sol of palladium—silver alloy, so that the sol is supported by the surface of the third plate 33. Thereafter, a heat treatment is performed to sinter the sol at temperature ranging from 300 to 600° C. so that the sol becomes a membrane. The surface of the third plate 33 is coated with the sol of palladium—silver alloy using a widely known method such as dipping, spin coating and screen printing.

In this method, it is unnecessary for palladium and silver to be alloyed on the surface of the third plate 33, since the sol of palladium—silver alloy which has been already alloyed is placed on the surface of the third plate 33. Therefore, in the heat treatment described above, only the sintering of the sol of palladium—silver alloy to form the membrane is required. In other words, the temperature for the heat treatment is set at a temperature (in this example, temperature not greater than 600° C.) lower than a temperature required for alloying palladium and silver (temperature over 600° C.). However, if the temperature of the heat treatment is less than 300° C., a coupling between the third plate 33 as the porous base and the palladium—silver alloy membrane becomes insufficient. Accordingly, it is preferable that the temperature for the heat treatment described above range from 300 to 600° C.

In the reactor RT2 configured as described above, high-temperature methanol and steam are introduced into the first space C1 via the through-hole 31a. They generate the steam-reforming reaction (CH₃OH+H₂O=CO₂+3H₂). The steam-reforming reaction is facilitated by the catalyst supported by the porous bodies 40 disposed in the through-holes 33a. In addition, the hydrogen separation membrane 50 transports only hydrogen generated from the steam reaction into the second space C2. As a result, the steam-reforming reaction is effectively generated. The hydrogen flown into the second space C2 is taken out via the through-hole 35a to be supplied to a fuel cell.

In this reactor RT2, gas having reached the hydrogen separation membrane inevitably passes through the porous body 40 supporting the catalytic material. Therefore, since the opportunities for the gas to contact the catalytic material increase, the steam-reforming reaction is effectively generated.

<Manufacturing Method>

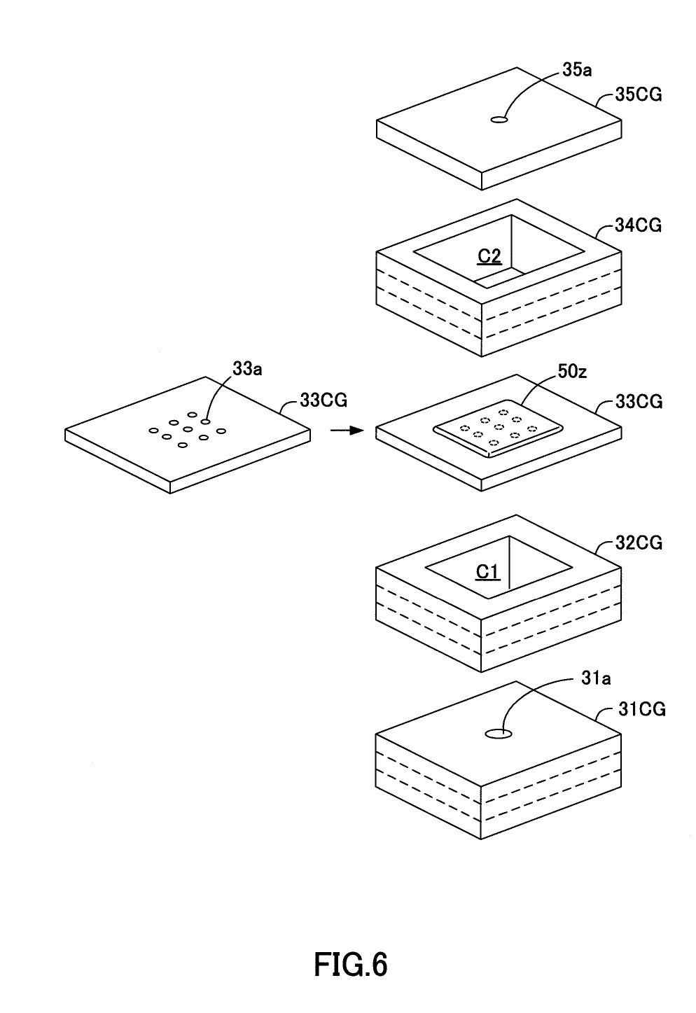

Next, manufacturing methods for the reactor RT1 and RT2 are briefly described referring to FIG. 6, taking the reactor RT2 as an example. It should be noted that, in the reactor RT2 manufactured using the manufacturing methods described below, the porous bodies 40 having the three dimensional net-like structure which supports the catalytic material are formed not only in the through-holes 33a, but also in the space (cavity) C1.

(1) First Manufacturing Method

Step 1: A ceramic green sheet 33CG which will become the third plate 33 later is prepared. The through-holes 33a are formed in the green sheet 33CG by punching process.
Step 2: Sol 50z of palladium—silver alloy which will become the hydrogen separation membrane 50 later is formed on an upper surface of the green sheet 33CG using a screen printing method so that the through-holes 33a formed in step 1 are covered by the sol 50z.
Step 3: Ceramic green sheets 31CG, 32CG, 34CG and 35CG which will later become the first plate 31, the second plate 32, the forth plate 34 and the fifth plate 35, respectively, are produced. Each of these ceramic sheets may be formed by laminating a plurality of ceramic sheets. The through-hole 31a is formed by the punching process in the ceramic green sheet 31CG which will become the first plate 31. Similarly, holes (windows) which will later form side wall surfaces of the space C1 and the space C2 are formed by the punching process in the ceramic green sheet 32CG which will later become the second plate 32 and the ceramic green sheet 34CG which will later become the forth plate 34, respectively. The through-hole 35a is formed by the punching process in the ceramic green sheet 35CG which will later become the fifth plate 35.
Step 4: The ceramic green sheets 31CG to 35CG are sequentially laminated and fired. At this time, the sol 50z which will become the hydrogen separation membrane 50 is also fired to become the hydrogen separation membrane 50.
Step 5: The gel (the gelatinized material) described above which will become the porous body having the three dimensional net-like structure which supports the catalytic material is poured into the space C1 from the through-hole 31a. Thereafter, the porous body 40 is obtained from the gel according to the method described above.

According to this first manufacturing method, the body 30 of the reactor RT2 is integrated by the firing of the ceramic green sheets, and thus, it excels in sealing characteristics. It should be noted that, since the hydrogen separation membrane 50 and the body are formed during the same firing process (step 4), it is necessary that a material which will become the hydrogen separation membrane 50 and a material which will become the body 30 (particularly, the third plate 33) are selected from materials whose shrinking ratios (contraction percentages) are similar to each other (i.e., materials which can be fired simultaneously).

(2) Second Manufacturing Method

Step 1: A ceramic green sheet 33CG which will later become the third plate 33 is prepared. The through-holes 33a are formed in the green sheet 33CG by punching process.
Step 2: Sol 50z of palladium—silver alloy which will later become the hydrogen separation membrane 50 is formed on an upper surface of the green sheet 33CG using a screen printing method so that the through-holes 33a formed in step 1 are covered by the sol 50z.
Step 3: Ceramic green sheets 31CG and 32CG which will later become the first plate 31 and the second plate 32, respectively, (in other words, the plates forming the space C1 later on), are produced in the same manner as Step 3 of the first manufacturing method.
Step 4: The ceramic green sheets 31CG, 32CG and 33C are sequentially laminated and fired. At this time, the gel which will become the hydrogen separation membrane 50 is also fired to become the hydrogen separation membrane 50. It should be noted that the hydrogen separation membrane 50 may be fired after the screen printing in Step 2 described above.
Step 5: Ceramic green sheets 34CG and 35CG which will later become the forth plate 34 and the fifth plate 35, respectively (in other words, the plates forming the space C2 later on), are produced in the same manner as Step 3 of the first manufacturing method.
Step 6: The ceramic green sheets 34CG and 35CG are sequentially laminated and fired. It should be noted that Steps 5 and 6 are independent from Steps 1 to 4, and thus, Steps 5 and 6 may be performed prior to Steps 1 to 4.
Step 7: The laminated body having the space C1 produced in Step 4 and the laminated body produced in Step 6 which will form the space C2 are coupled using a inorganic adhesive material (such as a silica series adhesive material).
Step 8: The gel (the gelatinized material) described above which will become the porous body having the three dimensional net-like structure which supports the catalytic material is poured into the space C1 from the through-hole 31a. Thereafter, the porous body 40 is obtained from the gel according to the method described above.
   (3) Third Manufacturing Method
Step 1: A ceramic green sheet 33CG which will later become the third plate 33 is prepared. The through-holes 33a are formed in the green sheet 33CG by punching process.
Step 2: Ceramic green sheets 31CG, 32CG, 33CG, 34CG and 35CG which will later become the first plate 31, the second plate 32, the third plate 33, the forth plate 34 and the fifth plate 35, respectively, are produced in the same manner as Step 3 of the first manufacturing method.
Step 3: The ceramic green sheets 31CG to 35CG are sequentially laminated and fired.
Step 4: Sol of palladium—silver alloy which will become the hydrogen separation membrane 50 is poured into the space C2 via the through-hole 35a of the fifth plate 35, and is heated and fired to produce the hydrogen separation membrane 50. Sol 50z of palladium—silver alloy which will later become the hydrogen separation membrane 50 is formed on an upper surface of the green sheet 33CG using a screen printing method so that the through-holes 33a formed in step 1 are covered by the sol 50z.
Step 5: The gel (the gelatinized material) described above which will become the porous body having the three dimensional net-like structure which supports the catalytic material is poured into the space C1 from the through-hole 31a. Thereafter, the porous body 40 is obtained from the gel according to the method described above.

It should be noted that, in the manufacturing methods described above, the catalytic material is added to the gel (the gelatinized material) in advance which will have the three dimensional net-like structure, and thereafter, it is dried and fired. Alternatively, a porous body having the three dimensional net-like structure may be formed first, and thereafter, the porous body may be made to support the catalytic material. A specific example for manufacturing method is explained below.

Step A: Formation of a Support Body (a Porous Body)

Polyethylene oxide (serial number 18198-6 made by Aldrich: molecular weight is one hundred thousand) which is a neutral macromolecule is dissolved in 1N nitric acid water solution of 6.61 g to obtain solution of 13.1% by weight. Tetraethoxysilane of 7 ml is added to the solution under agitation to generate a hydrolysis reaction for a few minutes. Thereafter, the transparent solution thus obtained is poured into the flow passage (the space C1 and the through-holes 33a), and is retained in a constant-temperature bath at 40° C. for eight hours to be solidified. Further, the solidified sample is mellowed for several hours, and is dried at 60° C. after it is washed using distilled water and ethanol several times. Next, the sample is heated to temperatures ranging from 600 to 900° C. at a temperature rise speed of 100° C./hour, and then it is retained for two hours at temperatures ranging from 600 to 900° C. As a result, the porous body having the three dimensional net-like structure is formed.

Step B: Supporting a Catalyst

Having the support body consisting of inorganic oxide such as the porous body described above support a catalyst can be performed by various types of methods including an impregnation method such as a heating-impregnation method, a room-temperature impregnation method, a vacuum impregnation method, a normal-pressure impregnation method, a treater method and a bore-filling method, as well as a soaking method, a low-degree infiltration method, a wet absorption method, a spray method and a coating method.

As one example, rhodium catalyst is supported by the impregnation drying-fixation (treater) method as below.
(1) The rhodium chloride trihydrate is impregnated into the porous body with using water solution of rhodium chloride trihydrate. At this time, the supported rate of rhodium is adjusted to be 0.5% by weight.
(2) The porous body is retained for one hour at a temperature of 500° C. to be fired, after it is dried at 100° C.

In the porous body having the three dimensional net-like structure obtained by this method, the rhodium catalysts are appropriately dispersed.

As explained above, in the reactors according to the present invention, the porous body having the three dimensional net-like structure is arranged in the flow passages, and thus, the fluid contacts the catalytic material frequently. This allows desired reactions to generate extremely effectively. In addition, the flow passage forming body 10 of the reactor RT1 and the body 30 of the reactor RT2 are formed by laminating the ceramic plates and firing the laminated plates. As a result, the sealed reactor from which gas does not leak can be provided.

Further, the reactor according to the present invention comprises a catalytic layer having the three dimensional net-like structure in the flow passage. The porosity of this catalytic layer is large, and thus, the movement of the fluid is hard to be blocked. Therefore, the pressure loss in the reactor according to the present invention is smaller, and heat conduction is better, compared to a reactor having a catalytic layer formed by filling powders in flow passages. Therefore, the reactor according to the present invention can facilitate the reaction.

The present invention is not limited to each of the embodiments described above, and various types of the modification can be made within the scope of the present invention. For example, in the reactor RT1, the upper wall portion 13 may be formed by a porous ceramic, and other functional membranes such as hydrogen separation membrane and the like may be arranged on the upper surface of the upper wall portion 13.

In addition, the present invention may be also applied to a reactor performing reactions described below.
(1) In a dehydrogenating reaction of cyclohexane (C₆H₁₂=C₆H₆+3H₂), the hydrogen in the right-hand side of the reaction formula is separated and deleted by a hydrogen separation membrane. As a catalytic material of this reaction, platinum, rhodium, rhenium and palladium and so on may be used.
(2) In a steam-reforming reaction of methane (CH₄+H₂O=CO+3H₂, CH₄+2H₂O=CO₂+4H₂) and CO shift reaction (CO+H₂O=CO₂+H₂), the hydrogen in the right-hand side of the reaction formula is separated and deleted by a hydrogen separation membrane. As a catalytic material of this reaction, nickel, magnesium-aluminum, and palladium-nickel and so on may be used.

1. A reactor comprising:
a flow passage forming member which has a space in its inside, the space being a flow passage formed by laminating and firing a plurality of ceramic plates, and
a porous body having a three dimensional net-like structure disposed in said space for supporting a catalytic material.

2. A reactor comprising:
a body having in its inside a space formed by laminating and firing a plurality of ceramic plates, the body having a through-hole in a wall forming the space, and
a porous body having a three dimensional net-like structure disposed in said through-hole for supporting a catalytic material.
